(19) United States
(12) Patent Application Publication
(10) Pub. No.: US 2007/0138904 A1
(43) Pub. Date: Jun. 21, 2007

(54) Flat-type single phase brushless DC motor

(75) Inventor: Jin Won Chae, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/641,692

(22) Filed: Dec. 20, 2006

(30) Foreign Application Priority Data
Dec. 21, 2005 (KR) 10-2005-0126848

(51) Int. Cl. H02K 21/12; H02K 1/00; H02K 1/22

(52) U.S. Cl. 310/268; 310/156.32; 310/216

(57) ABSTRACT

A flat-type single phase brushless direct current (BLDC) motor includes a rotor rotatably fixed to a shaft and having a permanent magnet attached to a lower side thereof; a stator plate installed below the rotor; a plurality of stator cores installed on the stator plate to face the permanent magnet, the stator cores including soft magnetic powder and arranged to be asymmetric with respect to a rotation radial direction of the rotor so as to determine a rotational direction of the rotor; and a multiplicity of coils each being wounded around corresponding one of the stator cores to form a magnetic field toward the permanent magnet.

### FIELD OF THE INVENTION

The present invention relates to a flat-type single phase brushless DC (BLDC) motor; and, more particularly, to a flat-type single phase BLDC motor having stator cores around which coils are wounded, thus capable of improving motor efficiency by minimizing a loss of magnetic fields while focusing the magnetic fields to a permanent magnet.

### BACKGROUND OF THE INVENTION

In general, a motor is a device that generates a rotary power by converting electric energy into mechanical energy, and it is widely employed in industrial apparatus as well as various household electronic appliances. The motor is largely divided into a direct current (DC) motor and an alternating current (AC) motor.

In case of a DC motor which has a brush, an electric current is flown to a coil and rectified as a result of a contact between a commutator and the brush. However, such a DC motor has a problem in that the brush is worn away. Thus, to overcome such a drawback, a brushless DC (BLDC) motor which does not employ a brush is widely utilized.

The BLDC motor has a wide range of application because it has a large torque and a high efficiency as well as high controllability. Though a two-phase or a three-phase BLDC motor is extensively employed in general, high-price driving circuit and detection circuit are required as the phase of the motor increases. Thus, a single phase BLDC motor is usually employed in such a low-price and simple-structure product as a driving unit for driving a cooling fan of, e.g., a computer.

Below, a conventional flat-type single phase BLDC motor will be described with reference to FIG. 1.

FIG. 1 is an exploded perspective view of a conventional flat-type single phase BLDC motor 10. As shown in FIG. 1, the conventional flat-type single phase BLCD motor 10 includes a single phase coreless stator 11 for generating a rotational torque when the electric current is applied thereto, and a rotor 12 rotated by the torque of the stator 11.

The careless stator 11 which is fixed to the lower portion of the rotor 12 has a stator yoke 11a; and armature coils 11b and 11c disposed on top of the stator yoke 11a. A wiring board 13 is attached to the stator yoke 11a.

The wiring board 13 has a driving circuit (not shown) which drives the armature coils 11b and 11c by applying the electric current to the armature coils 11b and 11c; a magnetic-pole detecting device (not shown) such as a Hall sensor for detecting magnetic poles of a ring magnet 12b of the rotor 12. In response to a driving signal, electric currents are applied to the armature coils 11b and 11c through the wiring board 13 to generate a rotational torque and rotate the rotor 12.

The rotor 12 has a rotor shaft 12a fixed at the center thereof, and the ring magnet 12b is installed at the lower side of the rotor 12, wherein the ring magnet 12b has N poles and S poles alternately arranged. Further, attached to the outside of the rotor 12 is a cooling fan 14 for blow during the rotation.

The rotor shaft 12a is installed in a bearing house 15a of a case 15 via bearings 15b and 15c, whereby the rotor 12 is rotatably fixed in the case 15.

The conventional flat-type single phase BLDC motor 10 having the above-described configuration is operated as follows. At an initial stage of the operation of the motor 10, either N poles or S poles of the ring magnet 12b of the rotor 12, which is stopped, are detected by the magnetic-pole detecting device such as the Hall sensor, and the detection result is sent to the wiring board 13. Then, the driving circuit of the wiring board 13 is operated to apply electric currents to the armature coils 11b and 11c, so that rotating magnetic fields are formed toward the ring magnet 12b. As a result, the rotor 12 is rotated repetitively, which rotates the cooling fan 14 as well to generate an air flow.

With regard to the conventional flat-type single phase BLDC motor 10, the magnetic fields generated from the coreless stator 11 are vertically oriented. However, it has been difficult to fabricate stator cores for providing passageways for the vertical magnetic fields by only laminating multiple silicon steel sheets of same shapes. Thus, due to the difficulty of the fabrication of the stator cores, the armature coils 11b and 11c have been wounded on the stator yoke 11a without stator cores. As a result, the magnetic field generated from the armature coils 11b and 11c could not be fully utilized in generating a torque for the rotation of the rotor 12, resulting in deterioration of the motor efficiency.

### SUMMARY OF THE INVENTION

It is, therefore, an object of the present invention to provide a flat-type single phase BLDC motor having stator cores around which coils are wounded; and magnetic field focusing plates of enlarged areas which is installed at the stator cores to face a permanent magnet, wherein the stator cores are formed by compressing soft magnetic powder and serve to minimize a loss of magnetic fields that are generated from the coils to create a torque, and the magnetic field focusing plates serve to focus the magnetic fields on the permanent magnet, thus improving the motor efficiency.

In accordance with an embodiment of the present invention, there is provided a flat-type single phase brushless direct current (BLDC) motor including: a rotor rotatably fixed to a shaft and having a permanent magnet attached to a lower side thereof; a stator plate installed below the rotor; a plurality of stator cores installed on the stator plate to face the permanent magnet, the stator cores including soft magnetic powder and arranged to be asymmetric with respect to a rotation radial direction of the rotor so as to determine a rotational direction of the rotor; and a multiplicity of coils each being wounded around corresponding one of the stator cores to form a magnetic field toward the permanent magnet.

### BRIEF DESCRIPTION OF THE DRAWINGS

The above and other objects and features of the present invention will become apparent from the following description of exemplary embodiments, given in conjunction with the accompanying drawings, in which:

FIG. 1 is an exploded perspective view of a conventional flat-type single phase BLDC motor;

FIG. 2 sets forth an exploded perspective view of a flat-type single phase BLDC motor in accordance with a first embodiment of the present invention;

FIG. 3 presents a cross sectional view of the flat-type singe phase BLDC motor in accordance with the first embodiment of the present invention;

FIG. 4 illustrates an enlarged view of “A” part of FIG. 3;

FIG. 5 offer a plan view of the flat-type single phase BLDC motor in accordance with the first embodiment of the present invention;

FIG. 6 provides an enlarged view of a first modification of “A” part of FIG. 3;

FIG. 7 depicts an enlarged view of a second modification of “A” part of FIG. 3;

FIG. 8 illustrates an enlarged view of a third modification of “A” part of FIG. 3; and

FIG. 9 shows an enlarged view of a fourth modification of “A” part of FIG. 3.

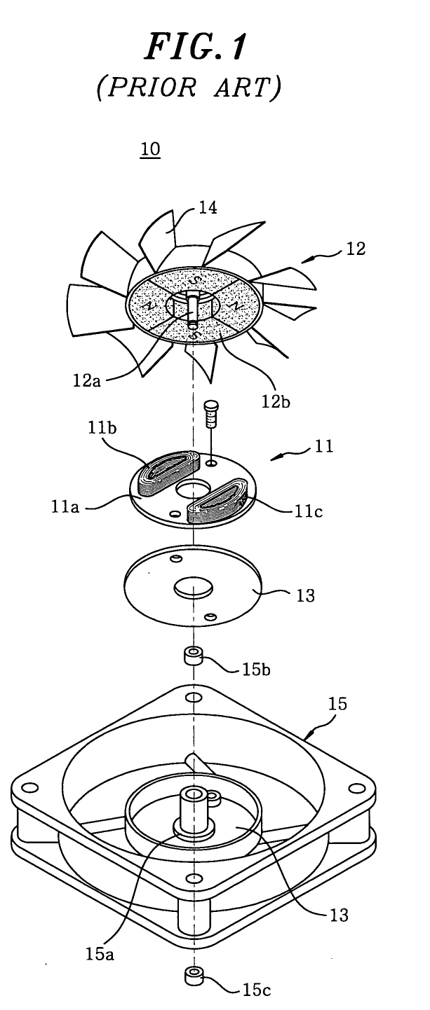

### DETAILED DESCRIPTION OF THE EMBODIMENTS

Hereinafter, exemplary embodiments of the present invention will be described in detail with reference to the accompanying drawings so that the present invention can be readily implemented by those skilled in the art.

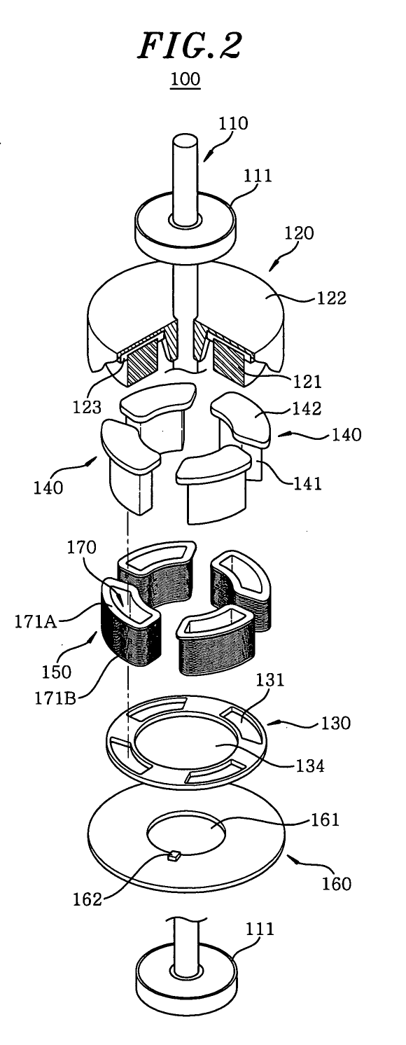

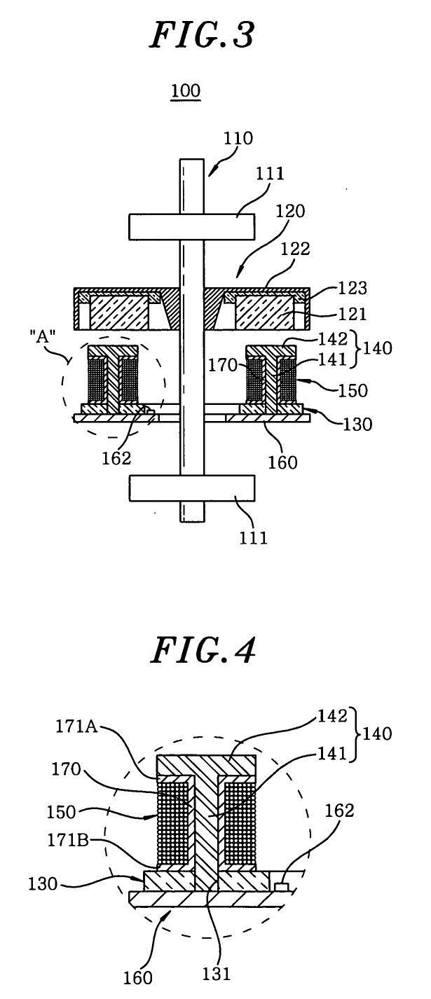

FIGS. 2 and 3 provide an exploded perspective view and a cross sectional view to illustrate a flat-type single phase BLDC motor assembly 100 in accordance with an embodiment of the present invention. FIG. 4 illustrates an enlarged view of “A” part of FIG. 3.

As shown, the flat-type single phase BLDC motor assembly 100 in accordance with the embodiment includes a shaft 110; a rotor 120 fastened to the shaft 110 and having a permanent magnet 121; a stator plate 130 installed below the rotor 120; a plurality of stator cores 140 arranged at the stator plate 130 at a regular interval in a circumferential direction of the stator plate 130 to face the permanent magnet 121; coils 150 wounded around the stator cores 140; and a control board 160 fastened to the bottom side of the stator plate 130.

The shaft 110 is rotatably installed in the case (not shown) of the motor assembly 100 via a bearing 111. Further, the shaft 110 is fixed through the center of the rotor 120, so it can be rotated along with the rotor 120.

The rotor 120 includes a circular cover 122 whose center is fixed at the shaft 110; a bracket 123 coupled to the bottom surface of the cover 122; and the permanent magnet 121 fastened to the bottom side of the bracket 123.

The permanent magnet 121 is a ring shaped magnet having N poles and S poles alternately magnetized and the number of the magnetic poles is set to be a multiple of two.

The stator plate 130 is installed in the case of the motor assembly 100 to be located below the rotor 120. The stator plate 130 is made up of a magnetic body and is provided at its center with a through hole 134 through which the shaft 110 is inserted with a clearance maintained between the surface of the hole 134 and the shaft 110. Further, the stator plate 130 has a plurality of lock holes 131 into which the plurality of stator cores 140 are inserted to be fixed thereat, wherein the lock holes 131 are provided at a regular interval in the circumferential direction of the stator plate 130.

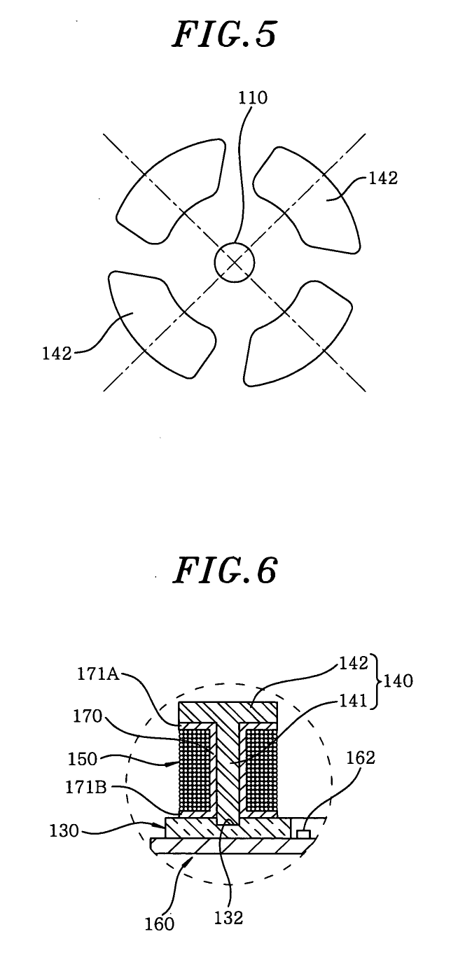

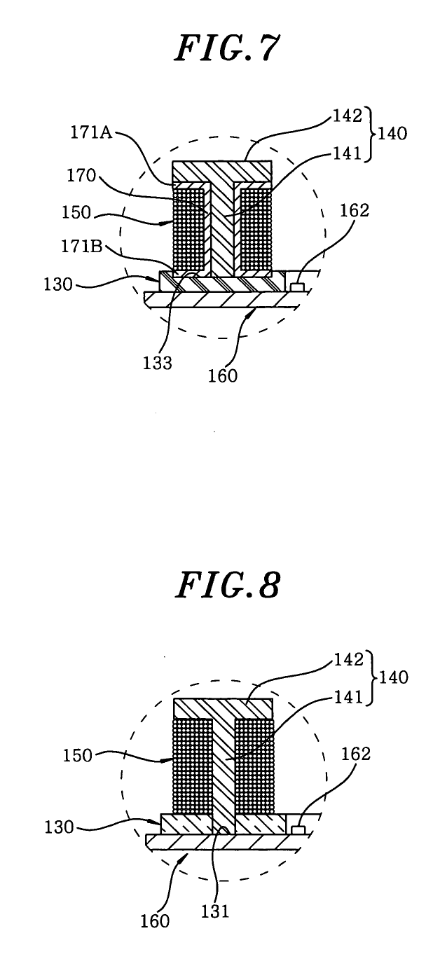

The number of the stator cores 140 is plural, e.g., a multiple of two. Each of the stator cores 140 is inserted through corresponding one of the lock holes 131 provided on the stator plate 130, so that the stator cores 140 are arranged at the regular interval maintained therebetween in the circumferential direction of the stator plate 130, facing the permanent magnet 120. Further, the stator cores 140 are formed by compressing soft magnetic powder and are arranged such that they are asymmetric with respect to a rotation radial direction of the rotor (see FIG. 5). The asymmetric arrangement of the stator cores 140 breaks a balance of a magnetic force applied to the permanent magnet 120 from the magnetic fields, thus making it possible to determine an initial rotational direction of the rotor 120.

Each stator core 140 has a body portion 141 inserted into corresponding one of the lock holes 131 of the stator plate 130; and a magnetic field focusing plate 142 formed at the top end of the body portion 141.

The body portion 141 is vertically formed, and corresponding one of the coils 150 is wounded around it.

The magnetic field focusing plate 142 is formed at the top end of the body portion 141 while being integrated with the body portion 141 as one body. The magnetic field focusing plate 142 has an enlarged area larger than the horizontal cross sectional area of the top portion of the body portion 141. The magnetic field focusing plates 141 serve to focus the magnetic fields generated from the coils 150 wounded around the body portions 141 toward the permanent magnet 121. As shown in FIG. 5, the magnetic field focusing plates 142 have approximately fan shapes, and they are arranged asymmetrically with respect to the rotation radial direction of the rotor 120, whereby the magnetic fields applied to the permanent magnet 121 gets unbalanced, thus making it possible to set the initial rotational direction of the rotor 120.

As the stator cores 140 are formed by compressing the soft magnetic powder, they can be formed to have a structure for guiding the magnetic fields of the coils 150 upward, and, further, by using the magnetic field focusing plates 142, the stator cores 140 can be configured to have “T” shapes. The soft magnetic powder is iron-based, and powder particles are coated to be insulated from each other.

To fabricate the stator cores 140 by compressing the soft magnetic powder, molding spaces corresponding to the shapes of the stator cores 150 are provided in a compression molding press, and after filling the molding spaces with the soft magnetic material, the mold is compressed by a compressing member such as a punch, so that the stator cores 140, each having a body portion 141 and a magnetic field focusing plate 142 integrated as one body, can be obtained. Here, a lubricant and/or a bonding material can be added to the soft magnetic material and compressed together.

Through the compressing process of the soft magnetic materials, the stator cores 150 are formed as soft magnetic composites (SMCs) having a three dimensional shape. In comparison with the conventional case using silicon steel plates, a high freedom is allowed in shaping the cores 140, so that each core 140 can be formed to have a configuration in which the body portion 141 and the magnetic field focusing plate 142 having an asymmetric structure are integrated as one body. The configuration has been difficult to obtain in the conventional case of attempting to form stator cores by laminating the silicon steel plates of same shapes.

The stator plate 130 is formed of a magnetic body which is made up of, e.g., a steel material. Further, it is also possible to form the stator plate 140 by compressing soft magnetic material as in the case of forming the stator cores 140, in which case various shapes of the stator plate 130 can be implemented.

As in the embodiment shown in FIGS. 2 to 4, the motor assembly 100 can further include insulators 170 connected to the stator cores 140 to cover the body portions 141 of the stator cores 140.

The insulators 170 can be made up of an insulating material such as a synthetic resin, a rubber, or similar material, and an upper flange 171A and a lower flange 171B are respectively formed at an upper and a lower end of each insulator 170 to insulate the coils 150 from the magnetic field focusing plates 142 of the stator cores 140 and from the stator plate 130.

Meanwhile, in the embodiment shown in FIGS. 2 to 4, the stator cores 140 are fixed to the stator plate 130 by inserting their body portions 141 into the lock holes 131 provided on the stator plate 130 through the insulators 170. However, the coupling mechanism for the fixation of the stator cores 140 to the stator plate 130 is not limited thereto. For example, the body portions 141 of the stator cores 140 can be fixed to the stator plate 130 by being inserted into lock grooves 132 which are formed at the stator plate 130 instead of the lock holes 130, as shown in FIG. 6. Alternatively, as illustrated in FIG. 6, by forming insertion grooves 133 corresponding to the volumes of the lower flanges 171B of the insulators 170, the lower end portions of the body portions 141 of the stator cores 140 and the lower flanges 171B of the insulators 170 can be inserted into the insertion grooves 133 of the stator plate 130 together, whereby the insulators 170 as well as the stator cores 140 can be fixed to the stator plate 130 altogether.

The coils 150 are wounded around the stator cores 140 to form magnetic fields toward the permanent magnet 121. As shown in FIGS. 2, 3, 4 and 6, the coils 150 are insulated from the stator plate 130 via the lower flange 171B as well as from the stator cores 140 via the insulators 170.

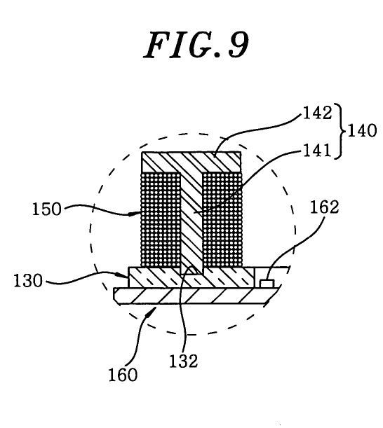

As illustrated in FIGS. 8 and 9, the coils 150 can be directly wounded around the stator cores 140 whose external surface are coated with an insulating material by bonding or adhesion instead of provision of the insulators 170.

Referring back to FIG. 2, the control board 160 is provided at the central portion with an opening 161 for allowing the shaft 110 to be inserted therethrough while a clearance is maintained between the shaft 110 and the surface of the hole 161. The control board 160 is attached to the bottom side of the stator plate 130. A driving circuit (not shown) which drives the coils 150 by applying electric currents to the coils 150 and/or a magnetic-pole detection sensor 162 such as a Hall sensor for detecting a magnetic-pole of the permanent magnet 121 is formed on the control board 160. The control board 160 is operated to apply electric currents to the coils 150 to generate a torque for rotating the rotor 120.

Below, an operation of the flat-type single phase BLDC motor assembly 100 having the above-described configuration will be explained.

If an operation signal is provided to drive the motor assembly 100, the driving circuit of the control board 160 applies electric currents to the coils 150 wounded around the stator cores 140, so that magnetic fields are generated from the coils 150. The magnetic fields thus generated are coupled with the permanent magnet 121 through the stator cores 140. The stator cores 140 are connected with each other via the stator plate 130, which is made up of a magnetic material, such that the magnetic fields propagate mutually. As a result, the rotor 12 is made to rotate.

The magnetic poles of the permanent magnet 121 are detected by the magnetic-pole detection device 162 installed on the control board 160, and the detection signal is transmitted to the driving circuit of the control board 160. In response to the detection signal, the electric power is supplied by the driving circuit to change the polarity of the coils 150 which in turn makes the coils 150 to have different magnetism. This allows the rotor 120 to rotate continually.

Meanwhile, since the stator cores 140, i.e., the magnetic field focusing plates 142 has two asymmetric parts with respect to the rotation radial direction of the rotor 120, the areas and the shapes of the two parts of the magnetic field focusing plates 142 facing the permanent magnet 121 are different from each, whereby the force of the magnetic fields generated from the coils 150 and applied to the permanent magnet 121 gets unbalanced, thus making it possible to determine the initial rotational direction of the rotor 120. Such an imbalance of the magnetic fields permits the permanent magnet 121 to be stopped at a constant position when stopping the rotor 120. Thus, by considering such a characteristic of the permanent magnet 121 relevant to the stop operation thereof, a motor capable of being driven promptly at an initial state can be fabricated.

Further, since the magnetic fields 121 coupled with the permanent magnet 121 from the stator cores 140 are focused on the permanent magnet 121 by the magnetic field focusing plate 142 disposed adjacent to the permanent magnet 121 and having enlarged areas greater than the cross section of the body portions 141, the magnetic force can be augmented, so that the motor efficiency can be improved.

As described above, the flat-type single phase BLDC motor in accordance with the present invention has stator cores around which coils are wounded. By the stator cores, losses of the magnetic fields generated from the coils to generate the rotational torque can be minimized, so that motor efficiency can be improved. Further, the stator cores have magnetic field focusing plates of enlarged areas which are configured to face a permanent magnet. The magnetic field focusing plates focus the magnetic fields on the permanent magnet, so that the motor efficiency can be further improved.

While the invention has been shown and described with respect to the embodiments, it will be understood by those skilled in the art that various changes and modifications may be made without departing from the spirit and scope of the invention as defined in the following claims.

What is claimed is:

1. A flat-type single phase brushless direct current (BLDC) motor comprising:
a rotor rotatably fixed to a shaft and having a permanent magnet attached to a lower side thereof;
a stator plate installed below the rotor;
a plurality of stator cores installed on the stator plate to face the permanent magnet, the stator cores including soft magnetic powder and arranged to be asymmetric with respect to a rotation radial direction of the rotor so as to determine a rotational direction of the rotor; and
a multiplicity of coils each being wounded around corresponding one of the stator cores to form a magnetic field toward the permanent magnet.

2. The motor of claim 1, wherein the stator plate is made up of a magnetic body.

3. The motor of claim 1, wherein the stator cores are arranged at a regular interval in a circumferential direction of the stator plate.

4. The motor of claim 3, wherein the stator cores is formed by compressing the soft magnetic powder.

5. The motor of claim 1, wherein the stator plate includes soft magnetic powder.

6. The motor of claim 5, wherein the stator plate is formed by compressing the soft magnetic powder.

7. The motor of claim 1, wherein each stator core includes:
a body portion inserted into the stator plate and fixed thereat to stand upright; and
a magnetic field focusing plate formed on a top end of the body portion to be integrated as one body therewith and having an enlarged area larger than a cross sectional area of the body portion,
wherein the coils are wounded around the body portions; and the magnetic field focusing plates are arranged asymmetrically with respect to the rotation radial direction of the rotor and serve to focus the magnetic fields of the coils to the permanent magnet.

8. The motor of claim 1, further comprising a number of insulators for insulating the coils from the stator cores.

9. The motor of claim 7, further comprising a number of insulators for insulating the coils from the stator cores.

10. The motor of claim 8, wherein the insulators are installed at corresponding one of the stator cores to insulate the coils from the stator cores.

11. The motor of claim 9, wherein the insulators are installed at corresponding one of the stator cores to insulate the coils from the stator cores.

12. The motor of claim 8, wherein the insulators are installed be fixed thereat by being inserted into the stator plate.

13. The motor of claim 1, wherein external surfaces of the coils are coated or covered with an insulating material to be directly wounded around corresponding one of the stator cores.

14. The motor of claim 7, wherein external surfaces of the coils are coated or covered with an insulating material to be directly wounded around corresponding one of the stator cores.
